(19) United States
(12) Patent Application Publication
(10) Pub. No.: US 2017/0287476 A1
(43) Pub. Date: Oct. 5, 2017

(54) VEHICLE AWARE SPEECH RECOGNITION SYSTEMS AND METHODS

(71) Applicant: GM GLOBAL TECHNOLOGY OPERATIONS LLC, Detroit, MI (US)

(72) Inventors: ELI TZIRKEL-HANCOCK, RA'ANANA (IL); SCOTT D. CUSTER, WARREN, MI (US); DAVID P. POP, GARDEN CITY, MI (US)

(73) Assignee: GM GLOBAL TECHNOLOGY OPERATIONS LLC, Detroit, MI (US)

(21) Appl. No.: 15/086,705

(22) Filed: Mar. 31, 2016

(51) Int. Cl. G10L 15/22

(52) U.S. Cl. CPC G10L 15/22; G10L 15/222; G10L 2015/225; G10L 2015/228

(57) ABSTRACT

Methods and systems are provided for processing speech for an autonomous or semi-autonomous vehicle. In one embodiment, a method includes receiving, by a processor, context data generated by the vehicle; determining, by a processor, a dialog delivery method based on the context data; and selectively generating, by a processor, a dialog prompt to the user via at least one output device based on the dialog delivery method.

### TECHNICAL FIELD

The technical field generally relates to speech systems and methods, and more particularly relates to speech systems and methods that take into account vehicle context information.

### BACKGROUND

Vehicle speech systems perform speech recognition on speech uttered by an occupant of the vehicle. The speech utterances typically include queries or commands directed to one or more features of the vehicle or other systems accessible by the vehicle.

In some instances, a user's communications with the speech system or other systems may be different for different environmental circumstances. For example, all or parts of speech utterances communicated to the speech system may be delayed when a driver is focusing on a particular driving maneuver. Accordingly, it is desirable to use the vehicle speech system to interact with the user in an improved manner during various driving conditions. It is further desirable to provide improved speech systems and methods for operating with an autonomous vehicle. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for processing speech for an autonomous or semi-autonomous vehicle. In one embodiment, a method includes receiving, by a processor, context data generated by the vehicle; determining, by a processor, a dialog delivery method based on the context data; and selectively generating, by a processor, a dialog prompt to the user via at least one output device based on the dialog delivery method.

In one embodiment, a system includes a non-transitory computer readable medium. The non-transitory computer medium includes a first module that receives, by a processor, context data generated by the vehicle. The non-transitory computer medium further includes a second module that determines, by a processor, a dialog delivery method based on the context data. The non-transitory computer medium further includes a third module that selectively generates, by a processor, a dialog prompt to the user via at least one output device based on the dialog delivery method.

### DESCRIPTION OF THE DRAWINGS

The exemplary embodiments will hereinafter be described in conjunction with the following drawing figures, wherein like numerals denote like elements, and wherein:

FIG. 1 is a functional block diagram of an autonomous vehicle that is associated with a speech system in accordance with various exemplary embodiments;

FIG. 2 is a functional block diagram of the speech system of FIG. 1 in accordance with various exemplary embodiments; and

FIGS. 3 through 5 are flowcharts illustrating speech methods that may be performed by the vehicle and the speech system in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

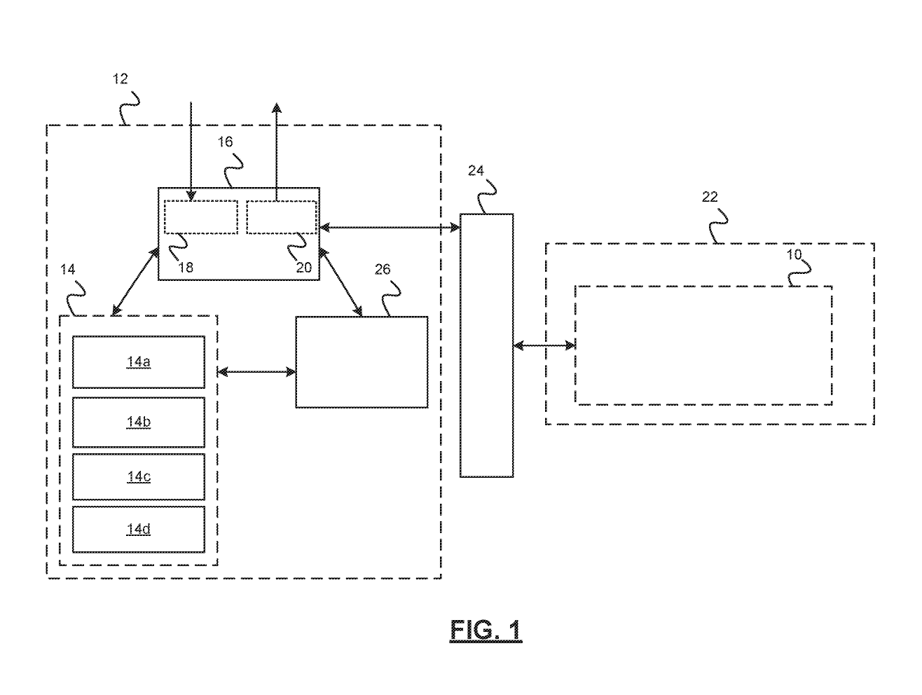

With initial reference to FIG. 1, in accordance with exemplary embodiments of the present disclosure, a speech system 10 is shown to be associated with a vehicle 12. The vehicle 12 includes one or more sensors that sense an element of an environment of the vehicle 12 or that receive information from other vehicles or vehicle infrastructure and control one or more functions of the vehicle 12. In various embodiments, the vehicle 12 is an autonomous or semi-autonomous vehicle. For example, the autonomous vehicle or semi-autonomous vehicle can be controlled by commands, instructions, and/or inputs that are “self-generated” onboard the vehicle. Alternatively or additionally, the autonomous vehicle or semi-autonomous vehicle can be controlled by commands, instructions, and/or inputs that are generated by one or more components or systems external to the vehicle 12, including, without limitation: other autonomous vehicles; a backend server system; a control device or system located in an external operating environment associated with the vehicle 12; or the like. In certain embodiments, therefore, a given autonomous vehicle can be controlled using vehicle-to-vehicle data communication, vehicle-to-infrastructure data communication, and/or infrastructure-to-vehicle communication.

The vehicle 12 further includes a human machine interface (HMI) module 16. The HMI module 16 includes one or more input devices 18 and one or more output devices 20 for receiving information from and providing information to a user. The input devices 18 include a microphone, a touch screen, an image processor, a knob, a switch and/or other sensing devices for capturing speech utterances or other communications (e.g., selections and/or gestures) by a user. The output devices 20 include, at a minimum, an audio device, a visual device, a haptic device, and/or other communication means for communicating a dialog prompt or other alert back to a user.

As shown, the speech system 10 is included on a server 22 or other computing device. In various embodiments, the server 22 and the speech system 10 may be located remote from the vehicle 12 (as shown). In various other embodiments, the speech system 10 and the server 22 may be located partially on the vehicle 12 and partially remote from the vehicle 12 (not shown). In various other embodiments, the speech system 10 and the server 22 may be located solely on the vehicle 12 (not shown).

The speech system 10 provides speech recognition and a dialog for one or more systems of the vehicle 12 through the HMI module 16. The speech system 10 communicates with the HMI module 16 through a defined application program interface (API) 24. The speech system 10 provides the speech recognition and the dialog based on a context provided by the vehicle 12. Context data is provided by the sensors or other systems of the vehicle 12; and the context is determined from the context data.

In various embodiments, the vehicle 12 includes a context data acquisition module 26 that communicates with sensors or other systems of the vehicle 12 to capture the context data. The context data indicates a level or mode of automation of the vehicle 12, a vehicle state (e.g., parked, static, moving, in a maneuver, etc.), visibility conditions, road conditions (e.g., rainy, foggy, rough, busy, etc.), driving type (e.g., city, freeway, country roads, etc.), driver state (e.g., distracted or focused as indicated by camera, aware of the car situation or not aware, slurred speech, emotion in speech, etc.), etc. As can be appreciated, these examples of context data and events are merely some examples, as the list may be exhaustive. The disclosure is not limited to the present examples. In various embodiments, the context data acquisition module 26 captures context data and evaluates the context data in realtime.

The context data acquisition module 26 then communicates the context data to the HMI module 16. In response, the HMI module may optionally alter or add information to the data, and communicate the context data to the speech system 10 through the API 24. The speech system 10 is then updated based on the context data.

Upon completion of speech processing by the speech system 10, the speech system 10 provides a dialog prompt, and a delivery method back to the HMI module 16 of the vehicle 12. The dialog prompt and the delivery method are then further processed by, for example, the HMI module 16 to deliver the prompt to the user or schedule an action by a system of the vehicle 12. By adjusting the delivery method based on the context data, the efficiency of communicating with the user via the speech system 10 is improved during various driving scenarios.

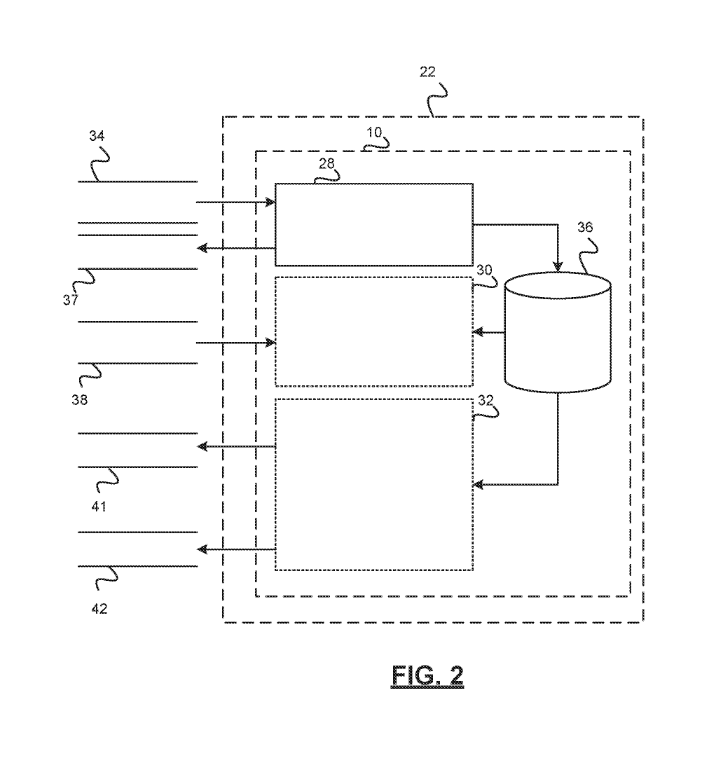

Referring now to FIG. 2 and with continued reference to FIG. 1, the speech system 10 is shown in more detail in accordance with various embodiments. The speech system 10 generally includes a context manager module 28, an automatic speech recognition (ASR) module 30, and a dialog manager module 32. As can be appreciated, the context manager module 28, the ASR module 30, and the dialog manager module 32 may be implemented as separate systems and/or as one or more combined systems in various embodiments.

The context manager module 28 receives the context data 34 from the vehicle 12. The context manager module 28 selectively sets a context of the speech processing and the dialog processing by storing the context data 34 in a context data datastore 36 and processing the stored data.

In various embodiments, the context manager module 28 processes the stored context data 34 to determine a dialog pace and/or a timing, an input modality, and/or an output modality. For example, in various embodiments, the context manager module 28 processes the context data 34 to determine the appropriate input and/or output modality of communication to be limited to be a less distracting communication means or to be not limited at all. For example, if the vehicle is operating in a particular maneuver or the road conditions are poor, then the output communication modalities can be limited to less distracting modality types such as, but not limited to, speech, or other audio alerts types; and the input modalities can be limited to less distracting modality types such as, but not limited to, speech and/or gesture types. In another example, if the vehicle is static or parked, then the input and output communication modality types do not have to be limited and can include textual, touch screen, or other interactive modality types.

In another example, the context manager module 28 processes the context data 34 to determine a dialog pace. The dialog pace can be associated with time periods associated with speech recognition and time periods associated with speech prompt delivery. In various embodiments, by adjusting the dialog pace, the timing associated with the various time periods may be increased, decreased, and/or delayed. For example, if the vehicle 12 is operating in a maneuver or the driver is distracted, then the dialog pace may indicate a speech prompt delivery pace and/or the speech recognition pace that is a slower pace (e.g., one or more increased time periods or one or more delayed time periods) or paused. In another example, if the vehicle 12 is entering a complex driving scene while the driver is engaged with the speech system, for example, searching for music, the dialog may be paused until the context data indicates that the scene eases up. In another example, if the vehicle is static or parked, then the dialog pace type may indicate a speech prompt delivery pace and/or a speech recognition pace that is a faster pace or more interactive pace (e.g., one or more shorter time periods).

The determined dialog pace and/or timing, input modality, and/or output modality is then stored with the associated context data 34 in the context data datastore 36 to be used by the ASR module 30 and/or the dialog manager module 32 for further speech processing. The context manager module 28 communicates a confirmation 37, indicating that the context has been set, back to the vehicle 12 through the HMI module 16 using the defined API 24.

During operation, the ASR module 30 receives speech utterances 38 from a user through the HMI module 16. The ASR module 30 generally processes the speech utterances 38 using one or more speech processing models and a determined grammar to produce one or more recognized results.

The dialog manager module 32 receives the recognized results from the ASR module 30. The dialog manager module 32 determines a dialog prompt 41 based on the recognized results. The dialog manager module 32 further dynamically determines a delivery method 42 based on the stored dialog pace and/or timing, input modality, and/or output modality. The dialog manager module 32 communicates the dialog prompt 41 and/or the delivery method 42 back to the vehicle 12 through the API. The HMI module 16 then communicates the prompt to the user and receives subsequent communications from the user based on the delivery method.

For example, the dialog manager module 32 processes the recognized results to determine a dialog. The dialog manager module 32 then selects an appropriate prompt from the dialog based on the recognized results and the context data 34 stored in the context data datastore 36. The dialog manager module then determines a delivery method to deliver the determined prompt based on the context data 34 stored in the context data datastore 36. The delivery method for the prompt includes, but is not limited to, a particular timing or pace of the prompt and a subsequent communications, a delivery mode, a receipt mode of a subsequent communication.

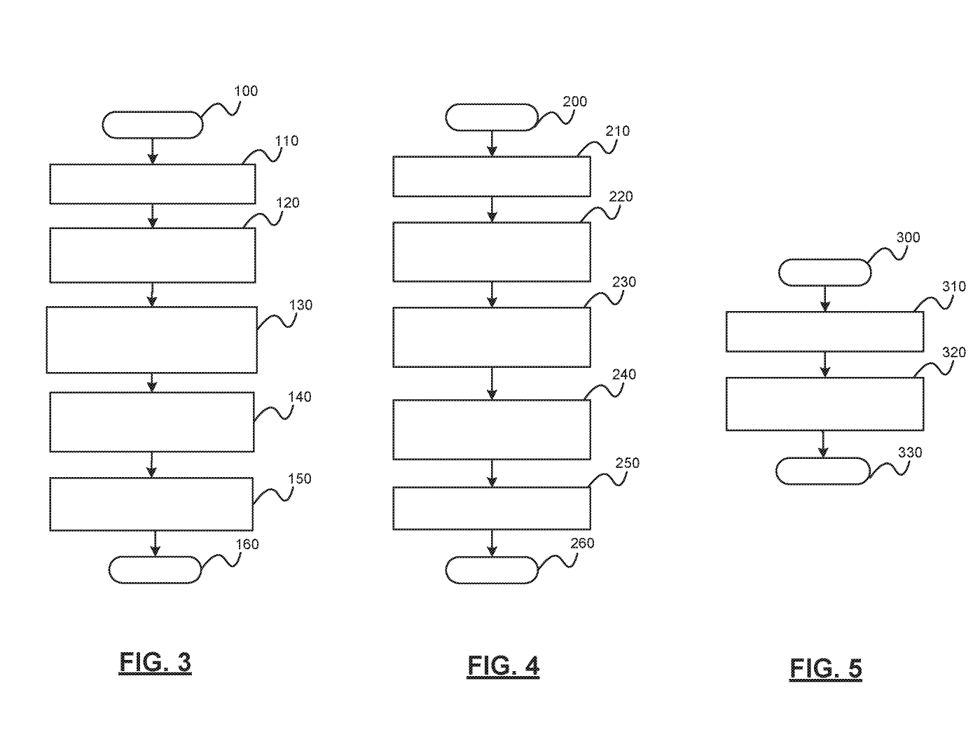

Referring now to FIGS. 3-5 and with continued reference to FIGS. 1-2, flowcharts illustrate speech methods that may be performed by the speech system 10 and/or the vehicle 12 in accordance with various exemplary embodiments. As can be appreciated in light of the disclosure, the order of operation within the methods is not limited to the sequential execution as illustrated in FIGS. 3-5, but may be performed in one or more varying orders as applicable and in accordance with the present disclosure. As can further be appreciated, one or more steps of the methods may be added or removed without altering the spirit of the method.

With reference to FIG. 3, a flowchart illustrates an exemplary method that may be performed to update the speech system 10 with the context data 34. As can be appreciated, the method may be scheduled to run at predetermined time intervals or scheduled to run based on an event.

In various embodiments, the method may begin at 100. The context data 34 is acquired from the vehicle 12 (e.g., directly from sensors, indirectly from other control modules, or systems of the vehicle) at 110. The context data is communicated to the speech system 10 from, for example, the HMI module 16 at 130. The context data 34 is processed to determine modalities, pace, and/or timings that would be best suitable for the vehicle context. The context data 34 and the determined modalities, pace, and/or timings are stored in the context data datastore 36 at 140. The confirmation 37 is generated and communicated back to the vehicle 12 through the HMI module 16 at 150. Thereafter, the method may end at 160.

With reference to FIG. 4, a flowchart illustrates an exemplary method that may be performed to process speech utterances 38 by the speech system 10 using the data stored in the context data datastore 36. The speech utterances 38 are communicated by the HMI module 16 to the speech system 10. As can be appreciated, the method may be scheduled to run based on an event (e.g., an event created by a user speaking).

In various embodiments, the method may begin at 200. The speech utterance 38 is received at 210. The speech utterance 38 is processed based on a grammar and one or more speech recognition methods to determine one or more recognized results at 220. The dialog is then determined from the recognized results at 230. The prompt and delivery methods are then determined based on the data stored in the context data datastore 36 at 240. The dialog prompt 41 and the delivery method is then communicated back to the vehicle 12 through the HMI module 16 at 250. Thereafter, the method may end at 260.

With reference to FIG. 5, a flowchart illustrates an exemplary method that may be performed by the HMI module 16 to process the dialog prompt 41 received from the speech system 10. As can be appreciated, the method may be scheduled to run based on an event (e.g., based on received user input).

In various embodiments, the method may begin at 300. The dialog prompt 41 and the delivery method 42 are received at 310. The dialog prompt 310 is communicated to the user via the HMI module 16 according the delivery method at 320. Thereafter, the method may end at 330.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of processing speech for an autonomous or semi-autonomous vehicle, comprising:
receiving, by a processor, context data generated by the vehicle;
determining, by a processor, a dialog delivery method based on the context data; and
selectively generating, by a processor, a dialog prompt to the user via at least one output device based on the dialog delivery method.

2. The method of claim 1, wherein the context data includes at least one of a level or mode of automation of the vehicle, a vehicle state, road conditions, and a driver state.

3. The method of claim 1, wherein the delivery method includes a dialog pace.

4. The method of claim 3, wherein the dialog pace includes one or more time periods associated with at least one of speech recognition and speech prompt delivery.

5. The method of claim 3, wherein the delivery method at least one of increases, decreases, or delays a dialog pace.

6. The method of claim 1, wherein the delivery method includes an indication of an input modality.

7. The method of claim 6, wherein the input modality is associated with at least one of a microphone, a touch screen, an image processor, a knob, and a switch.

8. The method of claim 1, wherein the delivery method includes an indication of an output modality.

9. The method of claim 8, wherein the output modality is associated with the at least one output device, and wherein the output device includes at least one of an audio device, a visual device, and a haptic device.

10. The method of claim 1, further comprising determining the dialog prompt based on the context data.

11. A system for processing speech for an autonomous or semi-autonomous vehicle, comprising:
a non-transitory computer readable medium comprising:
a first module that receives, by a processor, context data generated by the vehicle;
a second module that determines, by a processor, a dialog delivery method based on the context data; and
a third module that selectively generates, by a processor, a dialog prompt to the user via at least one output device based on the dialog delivery method.

12. The system of claim 11, wherein the context data includes at least one of a level or mode of automation of the vehicle, a vehicle state, road conditions, and a driver state.

13. The system of claim 11, wherein the delivery method includes a dialog pace.

14. The system of claim 13, wherein the dialog pace includes one or more time periods associated with at least one of speech recognition and speech prompt delivery.

15. The system of claim 11, wherein the delivery method at least one of increases, decreases, or delays a dialog pace.

16. The system of claim 11, wherein the delivery method includes an indication of an input modality.

17. The system of claim 16, wherein the input modality is associated with at least one of a microphone, a touch screen, an image processor, a knob, and a switch.

18. The system of claim 11, wherein the delivery method includes an indication of an output modality.

19. The system of claim 18, wherein the output modality is associated with the at least one output device, and wherein the at least one output device includes at least one of an audio device, a visual device, and a haptic device.

20. The system of claim 11, further comprising determining the dialog prompt based on the context data.
